(19) United States
(12) Patent Application Publication
(10) Pub. No.: US 2019/0270165 A1
(43) Pub. Date: Sep. 5, 2019

(54) MANUFACTURING METHOD FOR A POWER STORAGE DEVICE, MANUFACTURING METHOD FOR AN OUTER COVER FILM, AND POWER STORAGE DEVICE

(71) Applicant: TAIYO YUDEN CO., LTD., Tokyo (JP)

(72) Inventors: Daisuke TAKADA, Takasaki-shi (JP); Tomofumi AKIBA, Takasaki-shi (JP)

(21) Appl. No.: 16/286,372

(22) Filed: Feb. 26, 2019

(30) Foreign Application Priority Data
Mar. 2, 2018 (JP) 2018-037910

(51) Int. Cl. B23K 26/364; H01M 2/02; H01M 10/0525; H01M 10/058; H01M 2/12; B32B 15/08; B32B 3/30; H01G 11/80; H01G 11/12

(52) U.S. Cl. CPC B23K 26/364; H01M 2/0287; H01M 10/0525; H01M 10/058; H01M 2/1241; B32B 15/08; B32B 2457/16; H01G 11/80; H01G 11/12; B32B 2250/03; B32B 2250/40; B32B 2457/10; B32B 3/30

(57) ABSTRACT

Provided is a manufacturing method for a power storage device including: preparing an outer cover film including a metal layer including a first main surface and a second main surface on an opposite side of the first main surface, an inner resin layer made of a resin laminated on the first main surface, and an outer resin layer made of a resin laminated on the second main surface; radiating a laser to the outer cover film from a side of the outer resin layer and forming a groove, the groove penetrating the outer resin layer, reaching the metal layer, and having a depth between the first main surface and the second main surface; and forming a housing space surrounded by the inner resin layer, housing a power storage element and an electrolyte solution in the housing space, and sealing the outer cover film.

### CROSS REFERENCE TO RELATED APPLICATIONS

This application claims the benefit of Japanese Priority Patent Application JP 2018-037910 filed Mar. 2, 2018, the entire contents of which are incorporated herein by reference.

### BACKGROUND

The present disclosure relates to a manufacturing method for a power storage device including a power storage element sealed with an outer cover film, a manufacturing method for an outer cover film, and a power storage device.

In recent years, film-covered power storage devices each including a power storage element sealed with an outer cover film are widely used. In general, the outer cover film is obtained by laminating resins on both front and back surfaces of a barrier layer made of foil-shaped aluminum and the like.

In use of the film-covered power storage device, if a control circuit of the power storage device malfunctions with some cause and an abnormal voltage is applied or the surrounding temperature becomes abnormally high with some cause, some kind of gas may be generated due to electrolysis of an electrolyte solvent and an internal pressure of the power storage device may increase.

Then, the outer cover material of the film-covered power storage device having the increased internal pressure finally ruptures. Gas jets out from that position. However, it is unpredictable where such a rupture happens. Therefore, a peripheral device and the like may be adversely affected in a manner that depends on a position at which a rupture happens.

In order to overcome such a problem, a method of providing the outer cover film with a weak point by slitting a part of the outer cover film is conceivable.

For example, Japanese Patent Application Laid-open No. 2016-167575 (hereinafter, referred to as Patent Literature 1) has disclosed a manufacturing method for a power storage device, in which the outer cover film is slit with an ultrasonic cutter. Further, Japanese Patent Application Laid-open No. 2011-151030 (hereinafter, referred to as Patent Literature 2) has disclosed a manufacturing method for a battery apparatus, in which a resin layer, which is an outer layer of the outer cover film, is removed with a carbon dioxide laser.

### SUMMARY

However, as described above in Patent Literature 1, in a case of making a slit with the ultrasonic cutter, variations in the thickness of the outer cover film affect the slit depth of the barrier layer because of a processing method in which the slit is made in the outer cover film while the outer cover film is sandwiched from both the front and back surfaces. Therefore, a slit portion may not be ruptured at a desired pressure even when gas is generated and the internal pressure increases.

Further, when a slit is made with the ultrasonic cutter, the bottom surface of the slit groove has an acute angle. For example, in a case where the outer cover film is bent as a handling error in a manufacturing process, the barrier layer may be cracked and the product quality may be degraded.

Further, as described above in Patent Literature 2, in a case where only the resin layer which is the outer layer of the outer cover film is removed with the carbon dioxide laser, it is difficult to sufficiently lower the strength of a removed portion.

Therefore, the removed portion is not released even when the internal pressure increases, and the removed portion is released at a higher pressure. There is thus a fear that gas and electrolyte solution may be scattered.

Further, a structure in which linear removed portions cross each other is employed, and a duplicate laser is radiated to the crossing part. Therefore, in some laser radiation conditions, the barrier layer may be damaged and the product quality may be degraded.

In view of the above-mentioned circumstances, it is desirable to provide a manufacturing method for a power storage device, which can safely release an increased internal pressure in an abnormal case and which has high reliability, a manufacturing method for an outer cover film, and a power storage device.

In accordance with an embodiment of the present disclosure, there is provided a manufacturing method for a power storage device includes preparing an outer cover film including a metal layer including a first main surface and a second main surface on an opposite side of the first main surface, an inner resin layer made of a resin laminated on the first main surface, and an outer resin layer made of a resin laminated on the second main surface.

A laser is radiated to the outer cover film from a side of the outer resin layer and a groove is formed, the groove penetrating the outer resin layer, reaching the metal layer, and having a depth between the first main surface and the second main surface.

A housing space surrounded by the inner resin layer is formed, a power storage element and an electrolyte solution are housed in the housing space, and the outer cover film is sealed.

The outer cover film is provided with the groove reaching the metal layer. Abnormality is caused in the power storage element. When the internal pressure increases, the groove is cleaved and the internal pressure of the housing space is released. That is, the groove functions as a safety valve and the operating pressure of the safety valve depends on the depth of the groove. Here, by forming the groove in accordance with the above-mentioned manufacturing method, it becomes possible to form a groove having a desired depth irrespective of the thickness of the outer cover film and to correctly control the operating pressure of the safety valve.

In the manufacturing method for a power storage device, before radiating the laser to the outer resin layer, the inner resin layer may be crushed by heating and pressing and a first region in which the inner resin layer has a first thickness and a second region in which the inner resin layer has a second thickness smaller than the first thickness may be formed in the outer cover film.

In radiating the laser to the outer resin layer, the laser may be radiated to the second region.

By crushing the inner resin layer to lower the strength of the inner resin layer, the operating pressure of the safety valve can be lowered. Here, if the inner resin layer is crushed after the groove is formed with the laser, a bulge portion of groove formation may flow into the groove and the operating pressure of the safety valve may fluctuate. By forming the groove after crushing the inner resin layer as described above, the fluctuation of the operating pressure of the safety valve can be prevented.

The inner resin layer may include a resin having a melting point lower than the resin that constitutes the outer resin layer.

With this, only the inner resin layer can be crushed by performing heating and pressing.

The inner resin layer may be made of cast polypropylene, and

the outer resin layer may include

a first outer resin layer made of nylon and laminated on the second main surface, and

a second outer resin layer made of polyethylene terephthalate and laminated on the first outer resin layer.

With this configuration, the melting point of cast polypropylene is lower than the melting point of polyethylene terephthalate and nylon, and thus only the inner resin layer made of cast polypropylene can be crushed by heating and pressing.

The metal layer may be made of aluminum, and

in radiating the laser to the outer resin layer, a laser having a wavelength other than a wavelength range of a carbon dioxide laser may be radiated to the outer cover film and the groove may be formed.

The carbon dioxide laser is not absorbed by aluminum and the metal layer made of aluminum cannot be removed. Therefore, the groove needs to be formed with a laser having a wavelength other than the wavelength range of the carbon dioxide laser.

In accordance with an embodiment of the present disclosure, there is provided a manufacturing method for an outer cover film includes preparing an outer cover film including a metal layer including a first main surface and a second main surface on an opposite side of the first main surface, an inner resin layer made of a resin laminated on the first main surface, and an outer resin layer made of a resin laminated on the second main surface.

A laser is radiated to the outer cover film from a side of the outer resin layer and a groove is formed, the groove penetrating the outer resin layer, reaching the metal layer, and having a depth between the first main surface and the second main surface.

In accordance with an embodiment of the present disclosure, there is provided a power storage device includes a power storage element, an electrolyte solution, and an outer cover film.

The outer cover film includes a metal layer including a first main surface and a second main surface on an opposite side of the first main surface, an inner resin layer made of a resin laminated on the first main surface, and an outer resin layer made of a resin laminated on the second main surface, the inner resin layer surrounding a housing space in which the power storage element and the electrolyte solution are housed.

The outer cover film includes a groove formed, the groove penetrating the outer resin layer, reaching the metal layer, having a depth between the first main surface and the second main surface, and including a bottom surface having a curved surface shape.

When the groove is formed on the outer cover film by laser radiation, the groove including a bottom surface in a curved surface shape is formed. By forming the groove including the bottom surface in the curved surface shape, the metal layer can be prevented from being cracked and the product quality can be maintained.

As described above, in accordance with the present disclosure, it is possible to provide a manufacturing method for a power storage device, which can safely release an increased internal pressure in an abnormal case and which has high reliability, a manufacturing method for an outer cover film, and a power storage device.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a perspective view of a power storage device according to an embodiment of the present disclosure;

FIG. 2 is a cross-sectional view of the power storage device;

FIG. 3 is a plan view of the power storage device;

FIG. 4 is a cross-sectional view of an outer cover film of the power storage device;

FIG. 5 is a cross-sectional view of the outer cover film of the power storage device;

FIG. 6 is a cross-sectional view of the outer cover film of the power storage device;

FIG. 7 is a cross-sectional view of the power storage device;

FIG. 8 is a plan view of the power storage device;

FIG. 9 is a plan view of the power storage device;

FIG. 10 is a plan view of the power storage device;

FIG. 11 is a plan view of the power storage device;

FIG. 12 is a schematic view of a power storage module according to an embodiment of the present disclosure;

FIG. 13 is a cross-sectional view of a power storage device according to a modified example of the present disclosure;

FIG. 14 is a cross-sectional view of an outer cover film according to another modified example of the present disclosure;

FIG. 15 is a schematic view showing a formation range of a thin wall portion of an outer cover film of a power storage device according to an embodiment of the present disclosure;

FIGS. 16A and 16B are schematic views of a sealer which can be used for manufacturing the outer cover film of the power storage device;

FIGS. 17A and 17B are schematic views each showing a formation process for the thin wall portion in the outer cover film of the power storage device;

FIGS. 18A and 18B are schematic views each showing a formation process for a groove in the outer cover film of the power storage device; and

FIG. 19 is a schematic view showing an inspection process for the groove in the outer cover film of the power storage device.

### DETAILED DESCRIPTION OF EMBODIMENTS

Hereinafter, an embodiment of the present disclosure will be described with reference to the drawings.

Structure of Power Storage Device

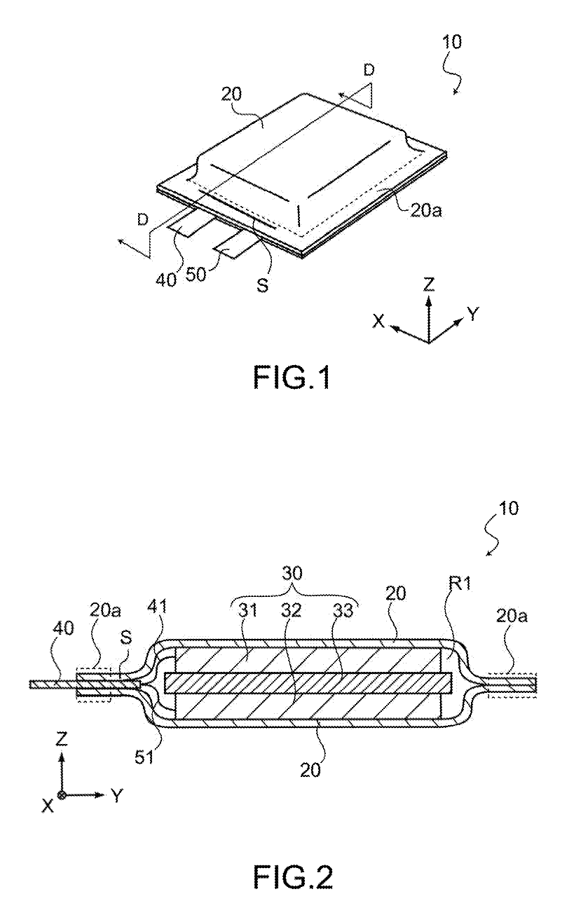

FIG. 1 is a perspective view of a power storage device 10 according to this embodiment. FIG. 2 is a cross-sectional view of the power storage device 10, which is taken along the line D-D of FIG. 1. In the following figures, the X direction, the Y direction, and the Z direction are three directions orthogonal to one another.

As shown in FIGS. 1 and 2, the power storage device 10 includes outer cover films 20, a power storage element 30, a positive electrode terminal 40, and a negative electrode terminal 50.

In the power storage device 10, an outer cover body constituted by the two outer cover films 20 forms a housing space R1. The power storage element 30 is housed in the housing space R1. The two outer cover films 20 are sealed at the periphery of the power storage element 30. The outer cover body includes a sealing portion 20a. The sealing portion 20a will be described later.

As shown in FIG. 2, the power storage element 30 includes a positive electrode 31, a negative electrode 32, and a separator 33. The positive electrode 31 and the negative electrode 32 face each other with the separator 33 interposed therebetween. The positive electrode 31 and the negative electrode 32 are housed in the housing space R1.

The positive electrode 31 functions as a positive electrode of the power storage element 30. The positive electrode 31 can be made of a positive electrode material including a positive electrode active material, a binder, and the like. The positive electrode active material is activated carbon, for example. The positive electrode active material is selected as appropriate in a manner that depends on the kind of the power storage device 10.

The negative electrode 32 functions as a negative electrode of the power storage element 30. The negative electrode 32 can be made of a negative electrode material including a negative electrode active material, a binder, and the like. The negative electrode active material is a carbon-based material such as graphite and hard carbon, for example. The negative electrode active material is selected as appropriate in a manner that depends on the kind of the power storage device 10.

The separator 33 is arranged between the positive electrode 31 and the negative electrode 32 so as to allow an electrolyte solution to pass therethrough and prevent contact between the positive electrode 31 and the negative electrode 32 (insulates the positive electrode 31 from the negative electrode 32). The separator 33 can be woven fabric, non-woven fabric, a resin microporous film, or the like.

In FIG. 2, the single positive electrode 31 and the single negative electrode 32 are provided. However, a plurality of positive electrodes 31 and a plurality of negative electrodes 32 may be provided. In this case, the plurality of positive electrodes 31 and the plurality of negative electrodes 32 can be alternately laminated with the separator 33 interposed therebetween. Further, the power storage element 30 may be a roll of a laminate of the positive electrode 31, the negative electrode 32, and the separator 33.

The kind of the power storage element 30 is not particularly limited. The power storage element 30 may be a lithium-ion capacitor, a lithium-ion battery, an electric double-layer capacitor, or the like. The electrolyte solution is housed in the housing space R1 together with the power storage element 30. The electrolyte solution is a solution of lithium hexafluorophosphate in propylene carbonate or the like, for example. The electrolyte solution can be selected in a manner that depends on the kind of the power storage element 30.

A positive electrode terminal 40 is an external terminal of the positive electrode 31. As shown in FIG. 2, the positive electrode terminal 40 is electrically connected to the positive electrode 31 via a positive electrode wire 41, passes between the two outer cover films 20 at the sealing portion 20a, and is pulled out from the inside of the housing space R1. The positive electrode terminal 40 can be an electrically conductive material made of foil, a wire, or the like.

A negative electrode terminal 50 is an external terminal of the negative electrode 32. As shown in FIG. 2, the negative electrode terminal 50 is electrically connected to the negative electrode 32 via a negative electrode wire 51, passes between the two outer cover films 20 at the sealing portion 20a, and is pulled out from the inside of the housing space R1. The negative electrode terminal 50 can be an electrically conductive material made of foil, a wire, or the like.

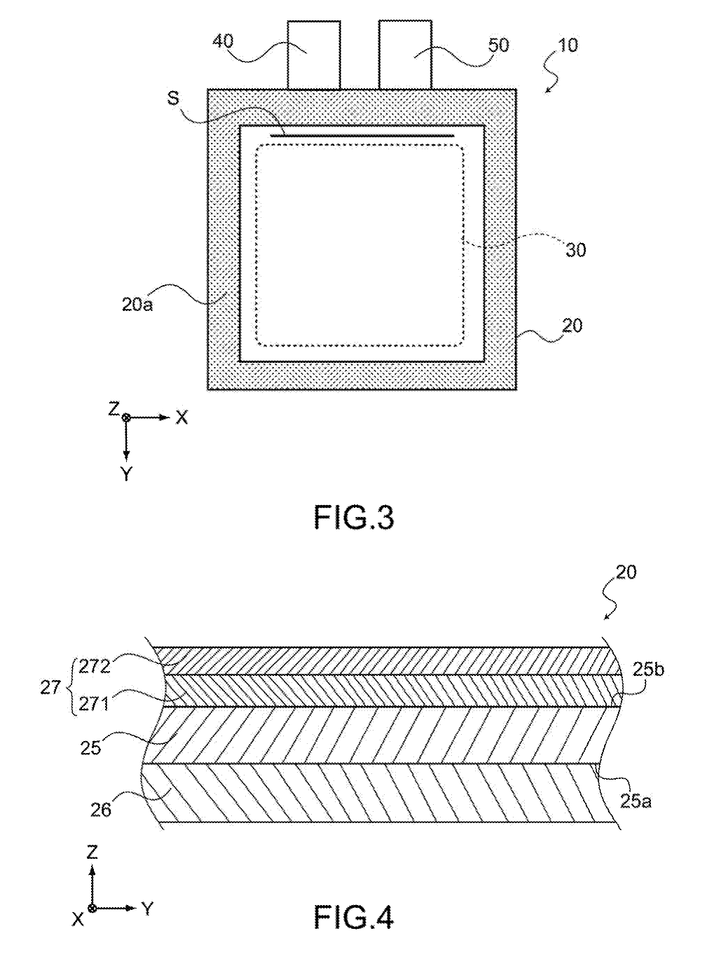

FIG. 3 is a schematic view as the power storage device 10 is viewed in the Z direction. As shown in the figure, the sealing portion 20a is formed at the periphery of the power storage element 30. The sealing portion 20a is formed by heat fusion of both the outer cover films 20 and seals the housing space R1. The sealing portion 20a can have a width of approximately several mm to several tens of mm, for example.

Configuration of Outer Cover Film

FIG. 4 is a cross-sectional view of the outer cover film 20. As shown in the figure, the outer cover film 20 is constituted by a metal layer 25, an inner resin layer 26, and an outer resin layer 27.

The metal layer 25 is a layer made of a foil-shaped metal and has a function of preventing moisture in the atmosphere from passing therethrough. As shown in FIG. 4, the metal layer 25 includes a first main surface 25a and a second main surface 25b on an opposite side of the first main surface 25a.

The metal layer 25 can be metal foil made of aluminum, for example. Alternatively, the metal layer 25 may be foil made of copper, nickel, stainless steel, or the like. The metal layer 25 has a thickness of 40 μm, for example.

The inner resin layer 26 is laminated on the first main surface 25a. The inner resin layer 26 constitutes an inner peripheral surface of the housing space R1. The inner resin layer 26 covers and insulates the metal layer 25.

The inner resin layer 26 can be made of a resin. The inner resin layer 26 can be made of cast polypropylene (CPP), for example. Alternatively, the inner resin layer 26 can be made of polyethylene, acid modifications thereof, polyphenylenesulfide, polyethylene terephthalate, polyamide, an ethylene-vinyl acetate copolymer, or the like. Further, the inner resin layer 26 may be constituted by a plurality of laminated resin layers. It should be noted that the constituent material of the inner resin layer 26 is favorably a material having a melting point lower than that of the constituent material of the outer resin layer 27. The inner resin layer 26 has a thickness of 80 μm, for example.

The outer resin layer 27 is laminated on the second main surface 25b. The outer resin layer 27 constitutes a surface of the power storage device 10. The outer resin layer 27 covers and protects the metal layer 25.

The outer resin layer 27 can be made of two resin layers. As shown in FIG. 4, the outer resin layer 27 includes a first outer resin layer 271 and a second outer resin layer 272, which are laminated on each other. Further, the outer resin layer 27 may be made of a single resin layer.

The first outer resin layer 271 can be made of oriented nylon (ON). The second outer resin layer 272 can be made of polyethylene terephthalate (PET). Alternatively, the material of the first outer resin layer 271 and the second outer resin layer 272 can be made of polyethylene naphthalate, oriented polypropylene, polyimide, polycarbonate, or the like.

It should be noted that the material of the outer resin layer 27 (the first outer resin layer 271 and the second outer resin layer 272) is favorably a material having a higher melting point than that of the constituent material of the inner resin layer 26. The thickness of the first outer resin layer 271 is 15 μm, for example. The thickness of the second outer resin layer 272 is 12 μm, for example.

The two outer cover films 20 having the above-mentioned configuration face each other with the power storage element 30 interposed therebetween. The housing space R1 is formed by the outer cover films 20 sealed with the sealing portion 20a. At the sealing portion 20a, the inner resin layers 26 of the two outer cover films 20 are heat-fused to each other. The outer cover films 20 are arranged such that the inner resin layers 26 are on the side of the housing space R1 (inside) and the outer resin layers 27 are on the side of the surface (outside). That is, the housing space R1 is surrounded by the inner resin layers 26. The outer cover film 20 has a thickness of 156 μm, for example.

The outer cover films 20 may be soft and may be deformed such that the periphery is curved conforming to the shape of the power storage element 30 as shown in FIG. 2. Further, the outer cover films 20 may be used with such a shape formed by embossing in advance. A groove is formed in either one of the two outer cover films 20.

Regarding Groove

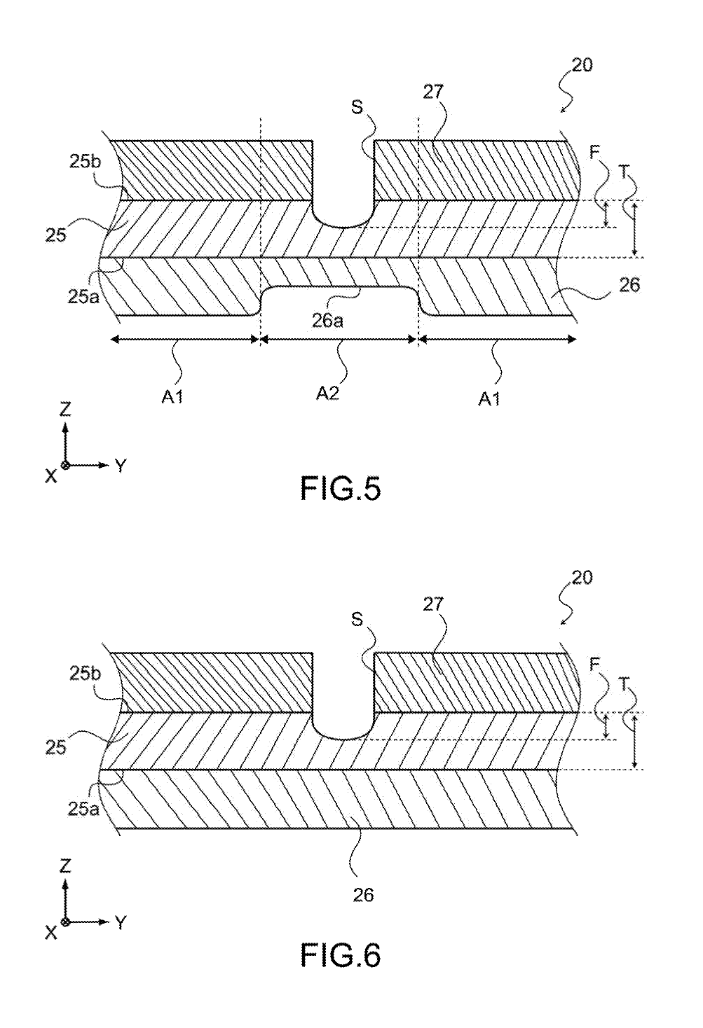

FIG. 5 is a cross-sectional view of the outer cover film 20 including a groove S. As shown in the figure, the outer cover films 20 includes first regions A1 and a second region A2. The groove S is formed in the second region A2.

Each of the first region A1 is a region in which the inner resin layer 26 has a first thickness L1.

The second region A2 is a region in which the inner resin layer 26 is provided with a thin wall portion 26a having a smaller thickness than that of the surrounding portion and in which the inner resin layer 26 has a second thickness L2 smaller than the first thickness L1.

It should be noted that the first thickness L1 and the second thickness L2 are not particularly limited, and are favorably thicknesses such that a difference between the first thickness L1 and the second thickness L2 is 20 μm or more and 50 μm or less.

As shown in the figure, the groove S penetrates the outer resin layer 27, reaches the metal layer 25, and is formed between the first main surface 25a and the second main surface 25b. The outer resin layer 27 is completely separated at the position at which the groove S is formed. The metal layer 25 is partially separated by the groove S.

As shown in FIG. 5, the groove S has a shape (U-shape) in which the bottom surface is a curved surface. That shape of the groove S can be formed by laser radiation to be described later.

As shown in FIG. 5, provided that the thickness of the metal layer 25 is T, a depth F of the groove S in the metal layer 25 only needs to be equal to or smaller than a thickness T. The depth F of the groove S in the metal layer 25 is favorably one tenth (T/10) or more and two thirds (2T/3) or less of the thickness T and more favorably one third (T/3) or more and one half (T/2) or less.

The groove S is formed in the second region A2. That is, the groove S is formed to face the thin wall portion 26a from the outer resin layer 27 with the metal layer 25 interposed therebetween. It should be noted that only a part of the groove S may face the thin wall portion 26a.

It should be noted that the thin wall portion 26a does not necessarily need to be provided. FIG. 6 is a cross-sectional view of the outer cover film 20 without the thin wall portion 26a. Also in this case, the groove S penetrates the outer resin layer 27, reaches the metal layer 25, is formed between the first main surface 25a and the second main surface 25b, and has a U-shape.

Effect of Groove

In use of the power storage device 10, the outer cover film 20 maintains the state shown in FIG. 5 or 6 during a normal time (in the state in which abnormality is not caused in the power storage element 30), that is, while the internal pressure of the housing space R1 is within an allowable range. In that state, the groove S does not completely separate the metal layer 25, and thus the metal layer 25 prevents the moisture from passing through the outer cover film 20.

In use of the power storage device 10, if abnormality is caused in the power storage element 30 and the internal pressure increases, the outer cover film 20 expands. With this, the metal layer 25 tears at the portion at which the groove S is formed. Subsequently, the inner resin layer 26 partially protrudes and expands outside the outer cover film 20 through a tear of the tearing metal layer 25. Then, when the internal pressure becomes equal to or higher than a certain level, the inner resin layer 26 protruding outside ruptures and the internal pressure of the housing space R1 is released.

Due to the formation of the groove S in this manner, it is possible to determine in advance a position at which the inner resin layer 26 will tear. If the groove S is not provided, the sealing portion 20a of the outer cover body, which is lowest in strength, cleaves and the internal pressure is released. In that case, it may be impossible to determine in advance which part of the sealing portion 20a formed at the entire periphery of the power storage element 30 will cleave.

In addition, the groove S has a U-shape as described above, and thus the metal layer 25 is less likely to tear even if force is added to the outer cover film 20 due to a handling error or the like. If the groove S has a V-shape or the like, the metal layer 25 tears when force is added to the outer cover film, and it may be impossible to prevent moisture from passing therethrough.

The depth of the groove S is favorably a depth with which the metal layer 25 prevents moisture from passing therethrough during normal operation and the metal layer 25 quickly tears in an abnormal case. Specifically, it can be realized by setting the depth F of the groove S in the metal layer 25 to be one tenth (T/10) or more and two thirds (2T/3) or less of the thickness T of the metal layer 25.

Further, the release of the internal pressure in the abnormal case is caused by the rupture of the inner resin layer 26 as described above. That is, the internal pressure (release pressure) at which the release is caused can be adjusted by the strength of the inner resin layer 26. The strength of the inner resin layer 26 can be adjusted by the thickness of the inner resin layer 26. As shown in FIG. 5, the strength of the inner resin layer 26 can be adjusted by providing the thin wall portion 26a.

In addition, as shown in FIG. 6, in the case where it is difficult to provide the thin wall portion 26a in the inner resin layer 26, the strength of the inner resin layer 26 can be adjusted by the thickness of the inner resin layer 26. In either case, the internal pressure caused by the rupture of the inner resin layer 26 in the groove S only needs to be lower than the internal pressure at which the sealing portion 20a cleaves.

Regarding Position and Shape of Groove

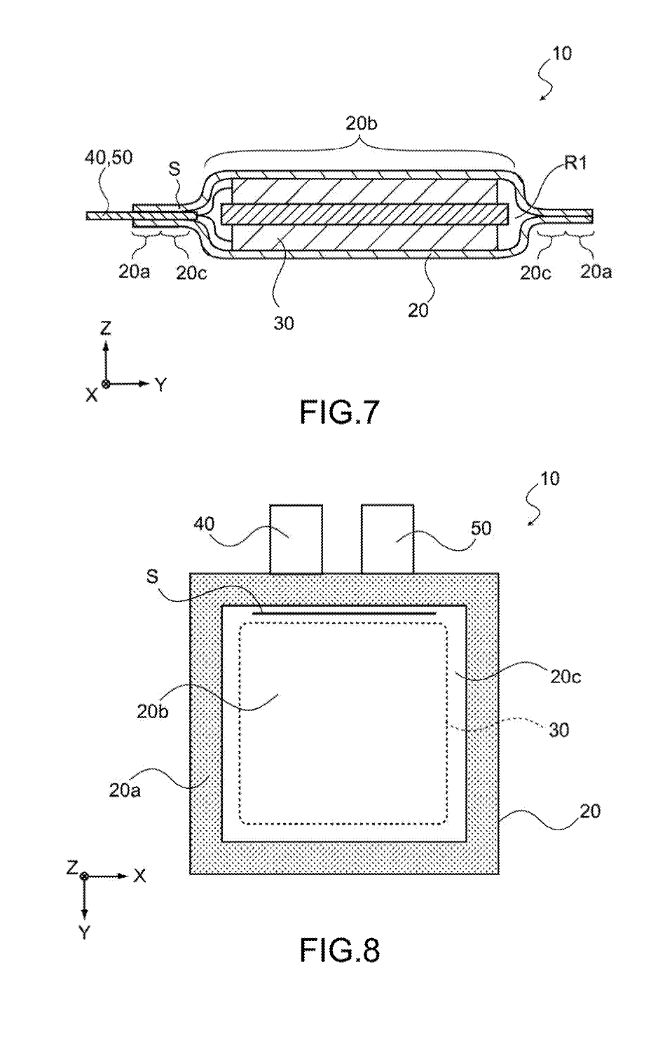

The groove S can be provided in any portion of the outer cover film 20, which excludes the sealing portion 20a. FIGS. 7 to 11 are schematic views each showing the groove S. FIG. 7 is a cross-sectional view of the power storage device 10. Each of FIGS. 9 to 11 is a plan view of the power storage device 10.

As shown in FIG. 7, a portion of the outer cover film 20, which houses the power storage element 30, is set as an element housing portion 20b and a portion between the element housing portion 20b and the sealing portion 20a is set as a middle portion 20c.

The element housing portion 20b is a portion molded in a recess shape by embossing or the like. The middle portion 20c is the portion between the element housing portion 20b and the sealing portion 20a. That is, the middle portion 20c is a portion heat-fused in contact with the outer cover film 20 that the middle portion 20c faces.

As shown in FIG. 8, the groove S can be formed in the middle portion 20c. Specifically, as shown in the figure, the groove S can be formed having a length of about several tens of mm and extends in parallel with a longitudinal direction of a portion of the sealing portion 20a, which is closest to the groove S.

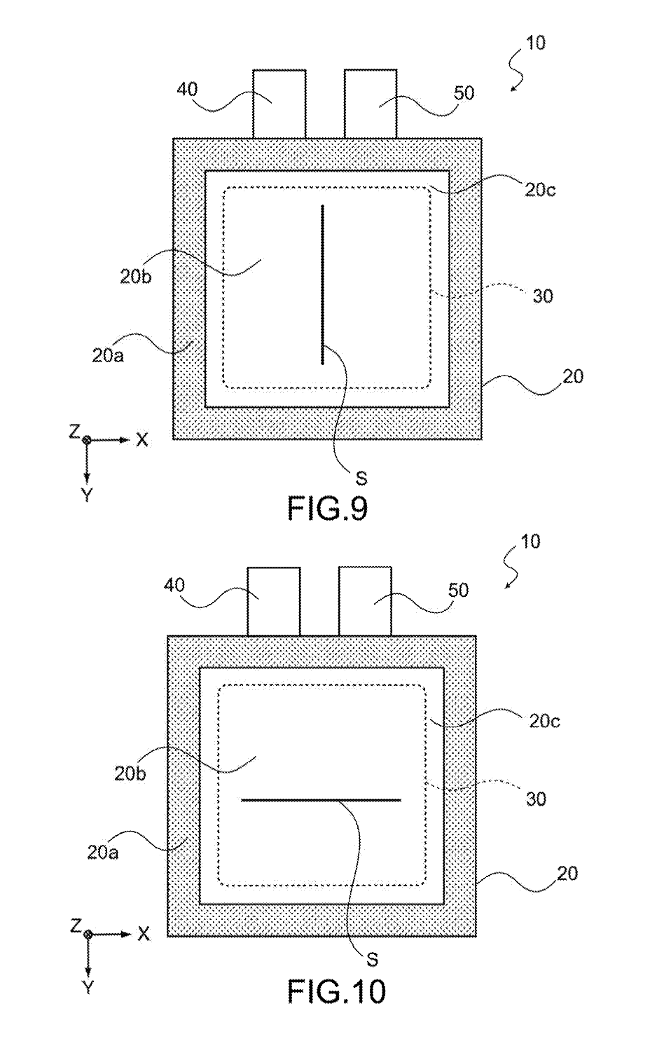

Further, the groove S does not necessarily need to be provided in the middle portion 20c. As shown in FIGS. 9 and 10, the groove S may be provided in the element housing portion 20b. The extending direction of the groove S is not particularly limited. As shown in FIG. 9, the extending direction of the groove S may be perpendicular to a longitudinal direction of a portion of the sealing portion 20a, which is provided with the positive electrode terminal 40 and the negative electrode terminal 50. As shown in FIG. 10, the extending direction of the groove S may be parallel to that longitudinal direction.

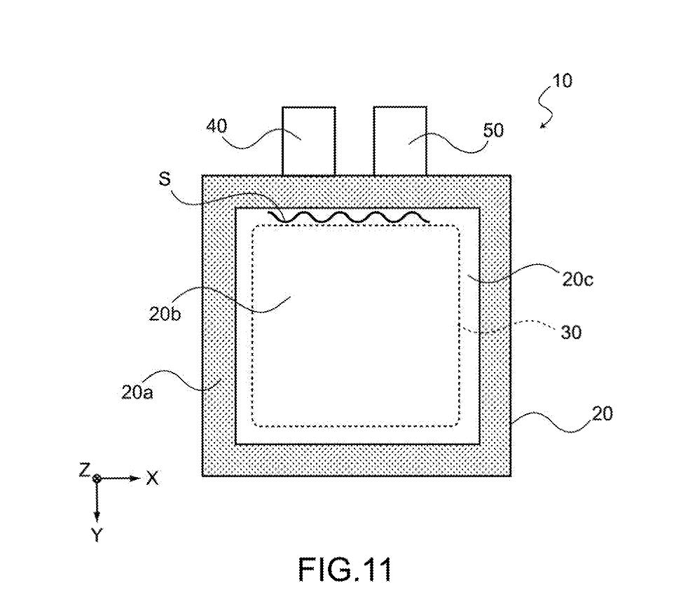

In addition, the groove S does not need to be linear. As shown in FIG. 11, the groove S may have a wave shape. Alternatively, the groove S can have various shapes including a triangular wave shape, a rectangle wave shape, and the like.

Regarding Power Storage Module

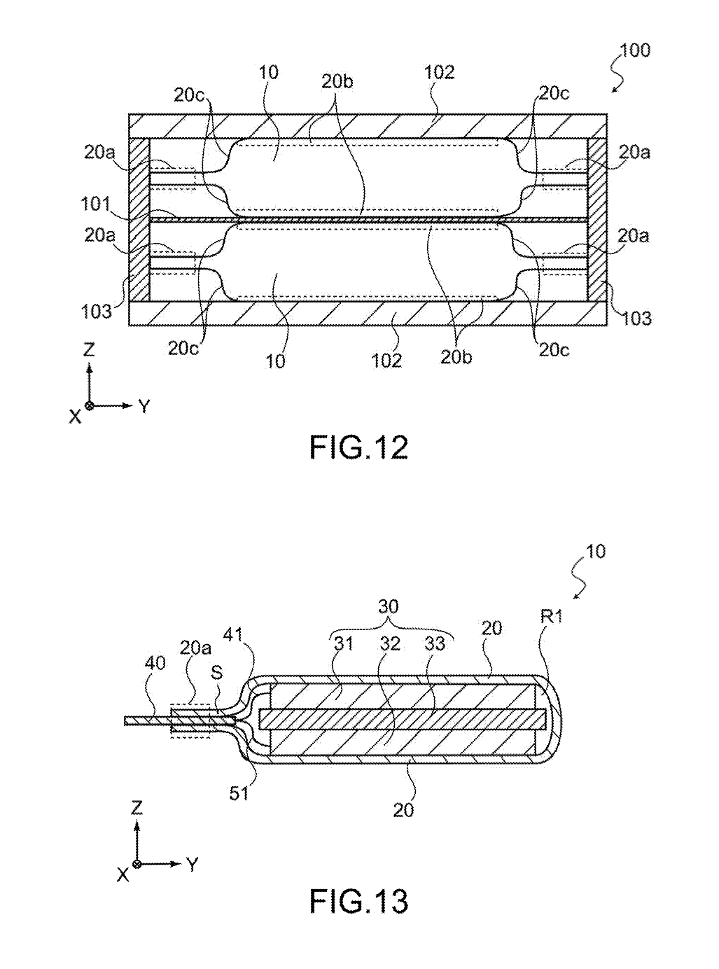

A power storage module can be formed by laminating a plurality of power storage devices 10 according to this embodiment. FIG. 12 is a schematic view of a power storage module 100. As shown in the figure, the power storage module 100 includes the plurality of power storage devices 10, a thermal conducting sheet 101, a plate 102, and a supporting member 103.

The plurality of power storage devices 10 is laminated via the thermal conducting sheet 101 and is supported by the supporting member 103. The number of power storage devices 10 may be two or more. The positive electrode terminal 40 and the negative electrode terminal 50 of the power storage device 10 can be connected between the power storage devices 10 via a wire or terminal (not shown). The plate 102 is laminated on an uppermost surface and a lowermost surface of the plurality of power storage devices 10.

As shown in the figure, when the power storage device 10 is laminated, the element housing portion 20b is held in contact with the thermal conducting sheet 101 and the plate 102. Therefore, in a case where the groove S is formed in the element housing portion 20b, those members interfere with expansion of the inner resin layer 26. In contrast, in a case where the groove S is formed in the middle portion 20c, expansion of the inner resin layer 26 is not interfered with and the internal pressure can be released at a predetermined pressure.

### Modified Example

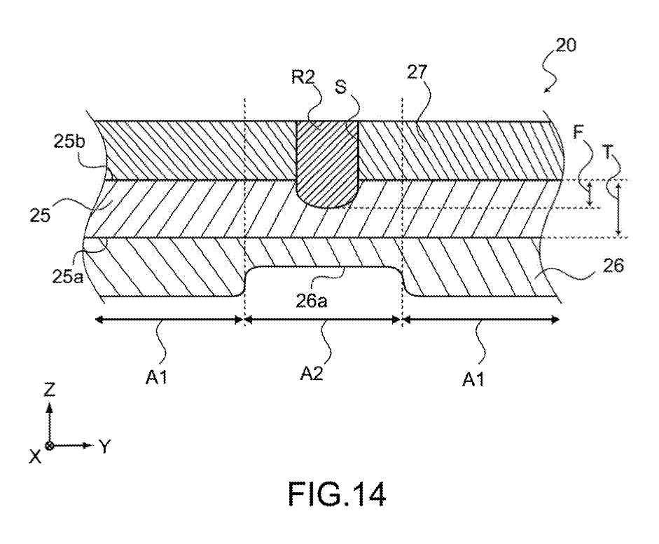

FIG. 13 is a cross-sectional view showing a power storage device 10 according to a modified example. FIG. 14 is a cross-sectional view of an outer cover film 20 according to another modified example. In the above-mentioned embodiment, in the power storage device 10, the outer cover body constituted by the two outer cover films 20 seals the housing space R1, though not limited thereto. As shown in FIG. 13, the power storage device 10 may be bent by the single outer cover film 20 via the power storage element 30 and a configuration in which the outer cover body formed with three sides sealed seals the housing space R1 may be employed. As shown in FIG. 13, the groove S can be provided in a portion of the outer cover film 20, which excludes the sealing portion 20a.

Further, as shown in FIG. 14, the outer cover film 20 may include the groove S in which an insulator R2 is embedded. In this case, a part of the groove S or the entire groove S is embedded in the insulator R2. The insulator R2 is not particularly limited. Various insulators such as a resin insulator, a paper insulator, and a glass insulator can be used. The resin insulator is favorable in view of the sealing property.

Manufacturing Method for Outer Cover Film

A manufacturing method for the outer cover film 20 according to this embodiment will be described. It should be noted that the manufacturing method shown below is an example and the outer cover film 20 can also be manufactured in accordance with a method different from the method shown below.

Formation Process for Thin Wall Portion

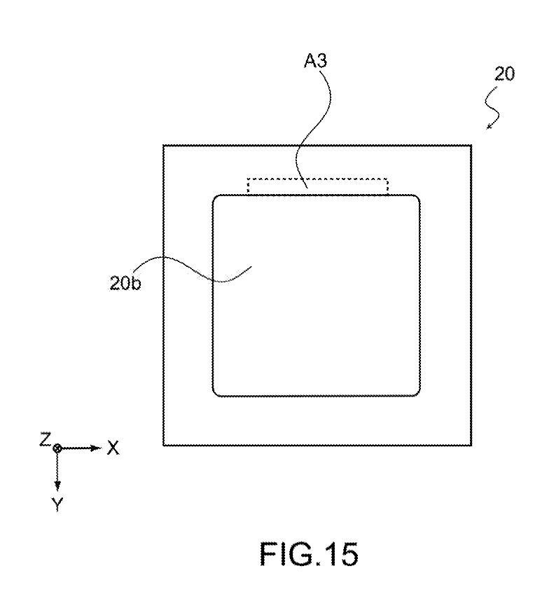

A formation method for the thin wall portion 26a will be described. FIG. 15 is a schematic view showing the outer cover film 20. In the outer cover film 20 shown in the figure, the element housing portion 20b has been formed by embossing. In the figure, a region in which the thin wall portion 26a is formed will be referred to as a region A3.

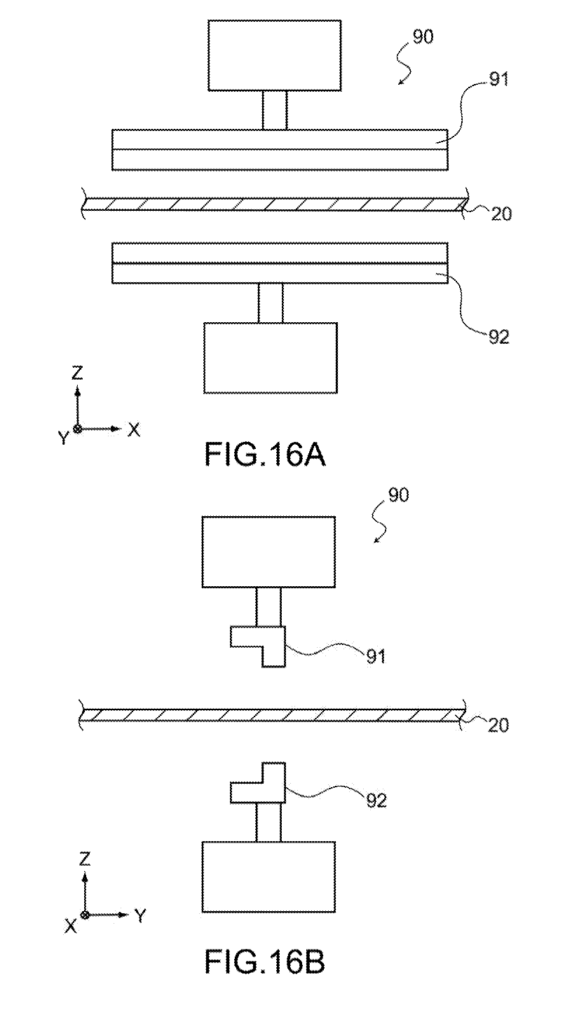

FIGS. 16A and 16B are schematic views of a heat sealer 90 used in formation of the thin wall portion 26a. FIG. 16A is a front view. FIG. 16B is a side view. The heat sealer 90 includes a front heater 91 and a back heater 92.

The front heater 91 presses and heats the outer cover film 20 from a side of the inner resin layer 26. The front heater 91 is capable of temperature control and has a function of varying heater pressing thrust to the outer cover film 20.

The back heater 92 presses and heats the outer cover film 20 from a side of the outer resin layer 27. The back heater 92 is capable of temperature control and has a function of varying heater pressing thrust to the outer cover film 20.

It should be noted that the front heater 91 and the back heater 92 are adjusted to be at the same temperature. Further, in order to ensure the uniformity of the thickness of the thin wall portion 26a, the parallelism of the front heater 91 and the back heater 92 is desirably adjusted to be within a range of ±0.02 mm.

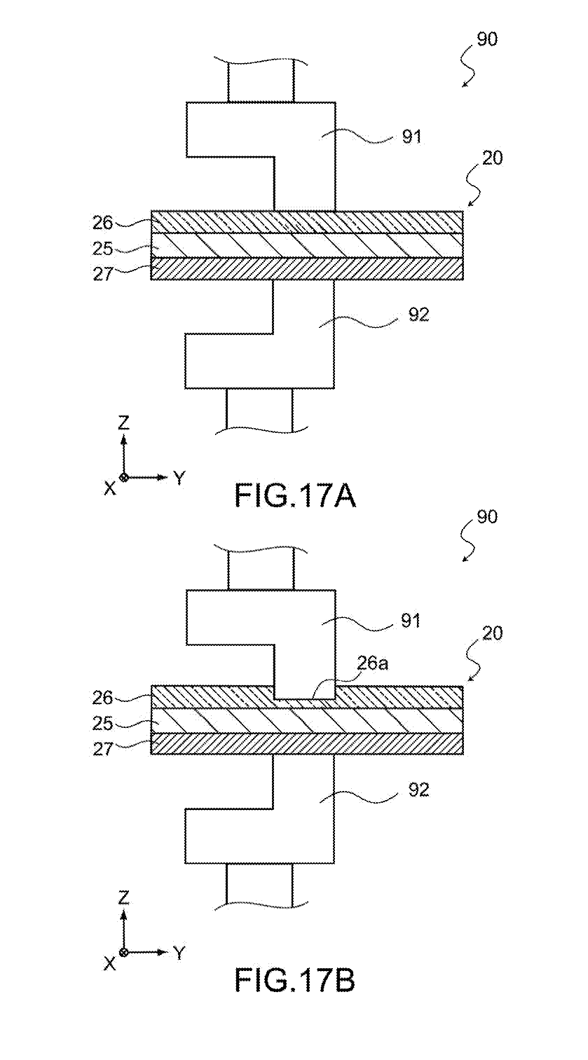

FIGS. 17A and 17B are schematic views each showing a formation process for the thin wall portion 26a. As shown in FIG. 17A, the outer cover film 20 is set to the heat sealer 90. At that time, setting is made such that inner resin layer 26 is located on a side of the front heater 91 and the outer resin layer 27 is located on a side of the back heater 92. Subsequently, the front heater 91 and the back heater 92 are pressed against the outer cover film 20 and heat the outer cover film 20.

Here, the inner resin layer 26 of the outer cover film 20 according to this embodiment can be made of a material having a melting point lower than that of the constituent material of the outer resin layer 27. With this, by setting the temperature of the front heater 91 and the back heater 92 to be higher than the melting point of the constituent material of the inner resin layer 26 and to be lower than the melting point of the constituent material of the outer resin layer 27, the thin wall portion 26a is formed only on the side of the inner resin layer 26 as shown in FIG. 17B.

By adjusting parameters of the front heater 91 and the back heater 92, such as temperature, thrust, and pressing time, the amount of crushing of the thin wall portion 26a can be controlled. For example, in a case where the inner resin layer 26 is made of CPP, the inner resin layer 26 can be crushed by 50 μm by setting the temperature of the front heater 91 and the back heater 92 to 170° C., setting the pressing time to 3 seconds, and setting the pressing force to 2800 N.

Groove Formation Process

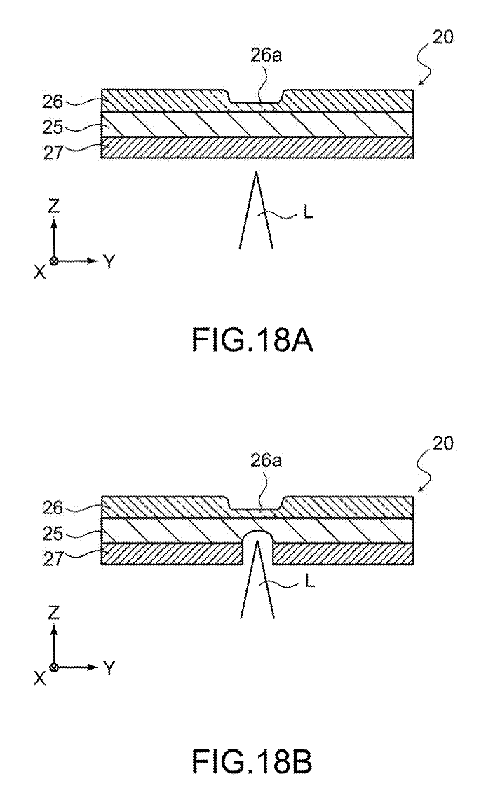

The groove S can be formed by laser radiation. FIGS. 18A and 18B are schematic views each showing a formation process for the groove S. In the formation process for the groove S, a laser L is radiated to an outer cover film 0 from the side of the outer resin layer 27 as shown in FIG. 18A. With this, at a laser radiation position, the outer resin layer 27 is completely removed and the metal layer 25 is partially removed to a middle position as shown in FIG. 18B.

The groove S is formed in the movement direction by moving the radiation position of the laser L. Movement of the radiation position can be performed by scanning of the laser by a galvanometer scanner, movement of the stage on which the outer cover film is placed, and the like.

Any kind of the laser can be used as long as the outer resin layer 27 can be completely removed and the metal layer 25 can be partially removed. Examples of such a laser can include a Yttrium Aluminum Garnet (YAG) laser and a Yttrium Orthovanadate (YVO₄) laser. It should be noted that the carbon dioxide laser cannot remove the metal layer 25, and thus the carbon dioxide laser is unsuitable.

The radiation condition of the laser is adjusted to remove the metal layer 25 at a predetermined depth. It should be noted that the laser L may be radiated multiple times. For example, only the outer resin layer 27 may be removed by first radiation and the metal layer 25 may be removed by performing second radiation to the removed part of the outer resin layer 27. Further, the output of the laser may be 70 to 80%.

For example, in a case where the first outer resin layer 271 is made of ON, the second outer resin layer 272 is made of PET, and the metal layer 25 is made of aluminum, the outer resin layer 27 can be removed and the metal layer 25 can be partially removed by using a radiation condition that the laser wavelength is 1062 nm, the machining rate is 100 mm/s, the pulse frequency is 50 kHz, and the number of times of radiation is twice.

It should be noted that if the outer cover film 20 is fixed at the time of laser radiation and the surface has irregularities, the depth of the groove S may not constant. Therefore, at the time of laser radiation, it is favorable to expose the radiation position, fix the outer cover film 20 with a zig pressing the periphery thereof, and remove irregularities.

The groove S can be formed in the above-mentioned manner. It should be noted that the above-mentioned formation process for the thin wall portion needs to be performed before the groove formation process. When the groove formation process is performed before the formation process for the thin wall portion, a bulge of a resin formed around the groove S by laser radiation in the groove formation process may enter the groove S in the formation process for the thin wall portion. It causes variations in the pressure at which the groove S cleaves, that is, the operating pressure of the safety valve.

Groove Inspection Process

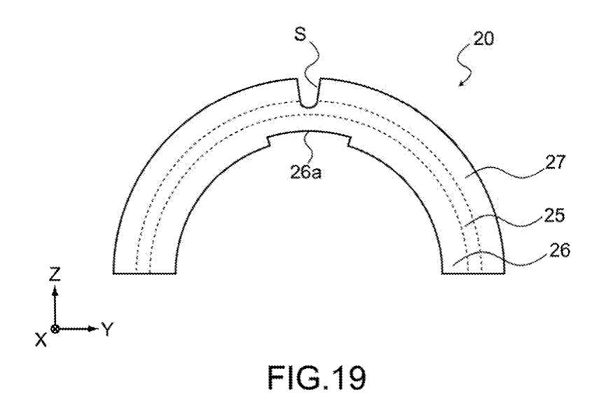

FIG. 19 is a schematic view of an inspection process for the outer cover film 20. After the thin wall portion 26a and the groove S are formed, the outer cover film 20 is bent in a semicircular shape as shown in FIG. 19 and the depth of the groove S is inspected.

Specifically, as shown in FIG. 19, the outer cover film 20 is bent in a semicircular shape so as to widen the groove S. Back light is emitted from the side of the inner resin layer 26 in a darkroom. Leakage of light is checked from the side of the outer resin layer 27. At that time, in a case where the metal layer 25 is penetrated or cracked, leakage of light from the groove S is found. In a case where the metal layer 25 has no abnormality, leakage of light from the groove S is not found.

By forming the outer cover film 20 in a semicircular shape, the groove S is forcibly opened, which makes it easy to check leakage of light. This inspection method is nondestructive inspection, and thus total inspection of the outer cover film 20 is possible.

It should be noted that in a case where adhesion of penetrant is allowed, the outer cover film 20 can also be subjected to inspection of the groove S using the penetrant.

Manufacturing Method for Power Storage Device

The power storage device 10 according to this embodiment can be manufactured by surrounding the power storage element 30 with the outer cover film 20 fabricated in accordance with the above-mentioned manufacturing method, being filled with an electrolyte solution, and being sealed with the sealing portion 20a. In a case where the housing space R1 is sealed with the two outer cover films 20, the outer cover film 20 including the groove S and the outer cover film 20 without the groove S can be used. In a case where the housing space R1 is sealed with the single outer cover film 20, the outer cover film 20 including the groove S can be used.

### EXAMPLES

Hereinafter, examples of the present disclosure will be described. The power storage device described in the above-mentioned embodiment was fabricated and evaluated.

### Example 1

First of all, an inner resin layer made of cast polypropylene (CPP) having a thickness of 80 μm was bonded to a metal layer made of aluminum having a thickness of 40 μm. Next, a first outer resin layer made of oriented nylon and having a thickness of 15 μm was bonded to a surface opposite to a surface of the metal layer on which the inner resin layer has been laminated. Subsequently, a second outer resin layer made of polyethylene terephthalate (PET) and having a thickness of 12 μm was bonded onto the first outer resin layer and an outer cover film having a thickness of 156 μm was fabricated.

Subsequently, the outer cover film was subjected to embossing and a recess portion to be an element housing portion was formed (see FIG. 7). Next, the thin wall portion was formed with a heat sealer. The machining condition of the heat sealer was set as follows: the front heater temperature was 170° C.; the back heater temperature was 170° C.; the pressing time was 3 seconds; and the pressing force was 2800 N. With this, the inner resin layer was crushed by about 50 μm and the thin wall portion was formed.

Next, a laser was radiated to the outer resin layer on the back side of the thin wall portion. The radiation condition of the laser was set as follows: the laser apparatus was MX-Z2000H (OMRON Corporation); the laser wavelength was 1062 nm; the machining rate was 100 mm/s; the pulse frequency was 50 kHz; the output was 70%; and the number of times of radiation was twice. Then, a linear groove having a length of 50 mm was formed.

Next, a work piece was fabricated by fixing an outer cover film in which a groove has been formed to a jig. The size of the work piece was as follows: the width (in the X direction) was 122 mm; the length (in the Y direction) was 136 mm; and the thickness (in the Z direction) was 17.8 mm.

In addition, an operating pressure test was conducted on the fabricated work piece. The operating pressure test was conducted by filling an internal space of the work piece with nitrogen gas. The flow rate of nitrogen gas was set to 400 ml/min.

Five work pieces as described above were fabricated and the operating pressure test was conducted. Then, all grooves of the five work pieces were cleaved. Table 1 shows a pressure (operating pressure) at the time of cleavage. The mean value of the operating pressure was 293 kPa, the maximum value was 330 kPa, the minimum value was 272 kPa, and the standard deviation (a) was 24 kPa.

TABLE 1

| No | Operating pressure [kPa] |
|---|---|
| 1 | 330 |
| 2 | 272 |
| 3 | 278 |
| 4 | 307 |
| 5 | 280 |

### Example 2

An outer cover film was fabricated and a thin wall portion was formed in a manner similar to that of Example 1. Next, a laser was radiated to the outer resin layer on the back side of the thin wall portion and a groove in a sine wave shape (see FIG. 11) was formed. The wave shape of the groove was set as follows: the wave line R was 3 mm; the wave line connection angle was 30 degrees; and the length was 50 mm.

The radiation condition of the laser was set as follows: the laser apparatus was MX-Z2000H(OMRON Corporation); the laser wavelength was 1062 nm; the machining rate was 100 mm/s; the pulse frequency was 50 kHz; the output was 80%; and the number of times of radiation was twice.

An outer cover film in which a groove has been formed was fixed to the jig and a work piece was fabricated. The size of the work piece was the same as Example 1. In addition, the operating pressure test was conducted in a manner similar to that of in Example 1.

Five work pieces as described above were fabricated and the operating pressure test was conducted. Then, all grooves of the five work pieces were cleaved. Table 2 shows a pressure (operating pressure) at the time of cleavage. The mean value of the operating pressure was 225 kPa, the maximum value was 271 kPa, the minimum value was 171 kPa, and the standard deviation (a) was 38 kPa.

TABLE 2

| No | Operating pressure [kPa] |
|---|---|
| 1 | 271 |
| 2 | 207 |
| 3 | 229 |
| 4 | 171 |
| 5 | 248 |

As described above, in accordance with Examples 1 and 2, the groove can be utilized as the safety valve in an abnormal case and it was confirmed that variations in the operating pressure thereof were small.

What is claimed is:

1. A manufacturing method for a power storage device, comprising:
preparing an outer cover film including
a metal layer including a first main surface and a second main surface on an opposite side of the first main surface,
an inner resin layer made of a resin laminated on the first main surface, and
an outer resin layer made of a resin laminated on the second main surface;
radiating a laser to the outer cover film from a side of the outer resin layer and forming a groove, the groove penetrating the outer resin layer, reaching the metal layer, and having a depth between the first main surface and the second main surface; and
forming a housing space surrounded by the inner resin layer, housing a power storage element and an electrolyte solution in the housing space, and sealing the outer cover film.

2. The manufacturing method for a power storage device according to claim 1, wherein
before radiating the laser to the outer resin layer, the inner resin layer is crushed by heating and pressing and a first region in which the inner resin layer has a first thickness and a second region in which the inner resin layer has a second thickness smaller than the first thickness are formed in the outer cover film, and
in radiating the laser to the outer resin layer, the laser is radiated to the second region.

3. The manufacturing method for a power storage device according to claim 2, wherein
the inner resin layer includes a resin having a melting point lower than the resin that constitutes the outer resin layer.

4. The manufacturing method for a power storage device according to claim 3, wherein
the inner resin layer is made of cast polypropylene, and
the outer resin layer includes
a first outer resin layer made of nylon and laminated on the second main surface, and
a second outer resin layer made of polyethylene terephthalate and laminated on the first outer resin layer.

5. The manufacturing method for a power storage device according to claim 1, wherein
the metal layer is made of aluminum, and
in radiating the laser to the outer resin layer, a laser having a wavelength other than a wavelength range of a carbon dioxide laser is radiated to the outer cover film and the groove is formed.

6. A manufacturing method for an outer cover film, comprising:
preparing an outer cover film including
a metal layer including a first main surface and a second main surface on an opposite side of the first main surface,
an inner resin layer made of a resin laminated on the first main surface, and
an outer resin layer made of a resin laminated on the second main surface, and
radiating a laser to the outer cover film from a side of the outer resin layer and forming a groove, the groove penetrating the outer resin layer, reaching the metal layer, and having a depth between the first main surface and the second main surface.

7. A power storage device, comprising:
a power storage element;
an electrolyte solution; and
an outer cover film including
a metal layer including a first main surface and a second main surface on an opposite side of the first main surface,
an inner resin layer made of a resin laminated on the first main surface, and
an outer resin layer made of a resin laminated on the second main surface, the inner resin layer surrounding a housing space in which the power storage element and the electrolyte solution are housed,
the outer cover film including a groove formed, the groove penetrating the outer resin layer, reaching the metal layer, having a depth between the first main surface and the second main surface, and including a bottom surface having a curved surface shape.
